(19) United States
(12) Patent Application Publication
(10) Pub. No.: US 2012/0167027 A1
(43) Pub. Date: Jun. 28, 2012

(54) ELECTRONIC DEVICE AND METHOD FOR CHECKING LAYOUT DISTANCE OF A PRINTED CIRCUIT BOARD

(75) Inventors: YA-LING HUANG, Shenzhen City (CN); SHI-PIAO LUO, Shenzhen City (CN); CHIA-NAN PAI, Tu-Cheng (TW); SHOU-KUO HSU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/172,858

(22) Filed: Jun. 30, 2011

(30) Foreign Application Priority Data
Dec. 28, 2010 (CN) 201010609748.3

(51) Int. Cl. G06F 17/50

(52) U.S. Cl. 716/111

(57) ABSTRACT

An electronic device and a method for checking layout distance of a printed circuit board (PCB) including presetting a checking condition to determine a reference layer. A high speed signal path is selected from a PCB design file, and a layer where the selected high speed signal path is located can be determined A reference layer of the determined layer is determined according to the checking condition, and a split line of the reference layer is determined. A shortest distance between each segment of the selected high speed signal path and the split line is calculated. If the shortest distance between a segment and the split line is less than the standard distance, layout of the segment is determined to be invalid.

### BACKGROUND

1. Technical Field

Embodiments of the present disclosure relate to technology of checking layout of a printed circuit board (PCB), and more particularly to an electronic device and method for checking layout distance of a PCB using the electronic device.

2. Description of Related Art

Generally, when a PCB design is finished, layout of the PCB needs to be checked to determine whether the layout accords with standard requirements. For example, if a distance between a high speed signal path of the PCB and an edge of a power layer or a ground layer of the PCB does not accord with the standard requirements, more radiation is produced and the integrity of transmission signals will be adversely affected. Thus, an electronic device and method for checking layout distance of a PCB is desired.

### BRIEF DESCRIPTION OF THE DRAWINGS

FIG. 1 is a block diagram of one embodiment of an electronic device.

FIG. 2 is a schematic diagram of one embodiment of a user interface provided by the electronic device of FIG. 1.

FIG. 3 is a flowchart of one embodiment of a method for checking layout distance of a printed circuit board using the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

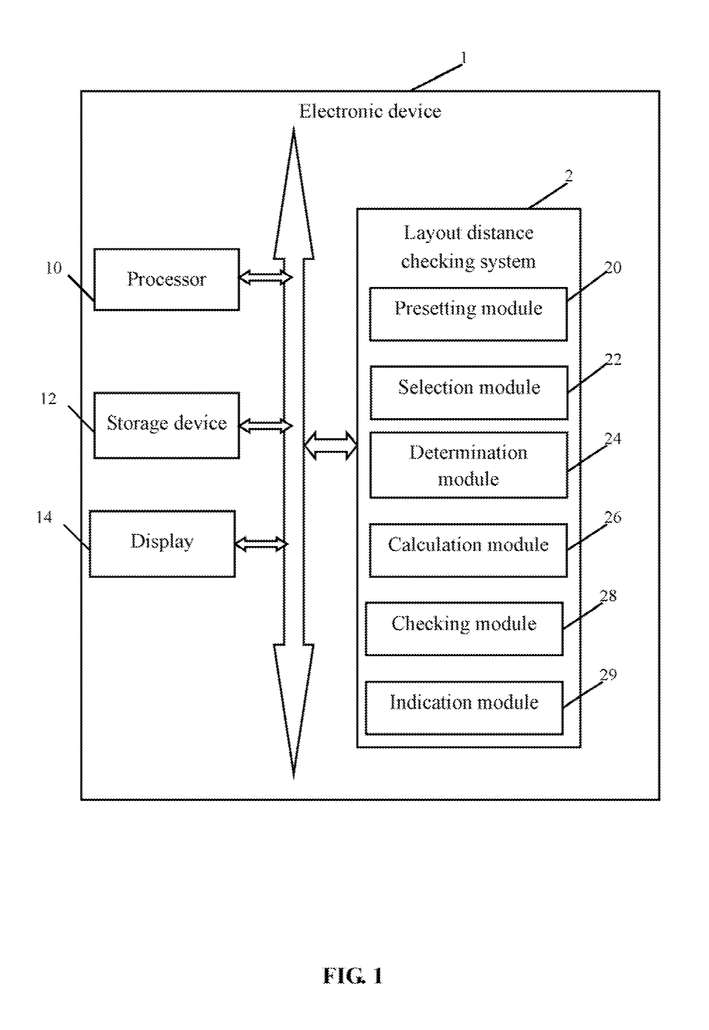

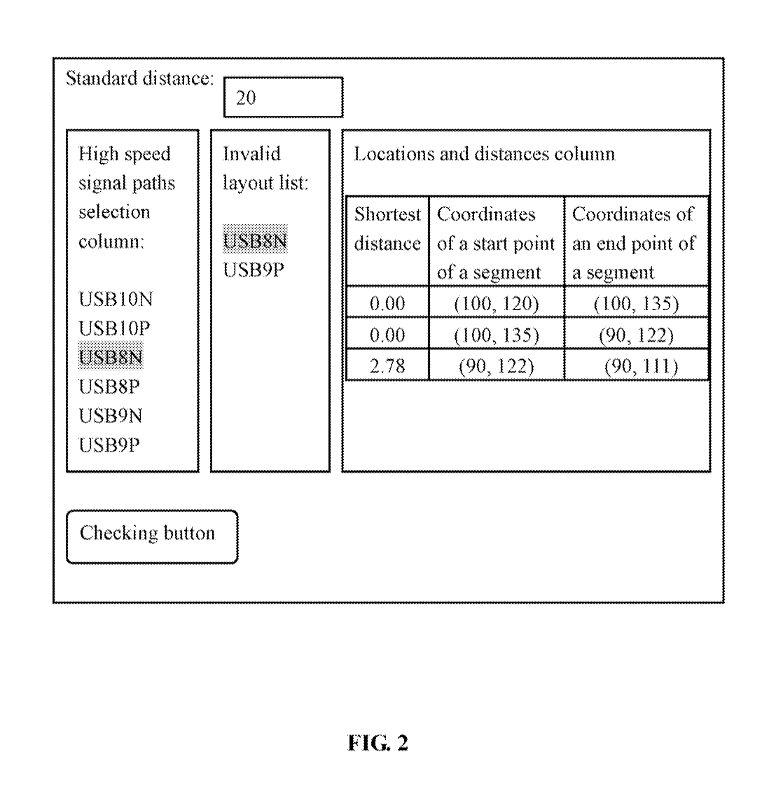

FIG. 1 is a block diagram of one embodiment of an electronic device 1. The electronic device 1 includes a layout distance checking system 2. The layout distance checking system 2 may be used to calculate distances between high speed signal paths of a printed circuit board (PCB) and edges of corresponding reference layers, and check if the distances accord with standard requirements. In some embodiments, the reference layer represents a power layer or a ground layer which is nearest to a layer where the high speed signal path is located. Detailed descriptions are provided below.

In some embodiments, the electronic device 1 may be a computer, a notebook computer, a computer server, or any other computing device. The electronic device 1 also includes at least one processor 10, a storage device 12, and a display 14. The at least one processor 10 executes one or more computerized operations of the electronic device 1 and other applications, to provide functions of the electronic device 1. The storage device 12 stores one or more programs, such as programs of the operating system, other applications of the electronic device 1, and various kinds of data, such as PCB design files. In some embodiments, the storage device 12 may include a memory of the electronic device 1 and/or an external storage card, such as a memory stick, a smart media card, a compact flash card, or any other type of memory card. The display 14 may display visible data, such as a user interface provided by the layout distance checking system 2, for example.

In some embodiments, the layout distance checking system 2 includes a presetting module 20, a selection module 22, a determination module 24, a calculation module 26, a checking module 28, and an indication module 29. The modules 20, 22, 24, 26, 28 and 29 may include computerized codes in the form of one or more programs stored in the storage device 12. The computerized codes include instructions executed by the at least one processor 10 to provide functions for modules 20, 22, 24, 26, 28 and 29. Details of these functions follow.

The presetting module 20 presets a checking condition to determine a power layer or a ground layer in the PCB design file nearest to a layer in the PCB design file having high speed signal paths as a reference layer. The presetting module 20 further presets a standard distance to determine if layouts of the high speed signal paths are valid. In some embodiments, the standard distance represents a distance between the high speed signal paths and the edge of the reference layer. The reference layer and the standard distance are used to check if layout of the high speed signal paths is valid. Detailed descriptions are provided below. The checking condition and the standard distance may be modified according to layout checking requirements of a user.

In some embodiments, the selection module 22 selects one of the high speed signal paths from the PCB design file stored in the storage device 12, and determines a layer in the PCB design file where the selected high speed signal path is located. In other embodiments, the selection module 22 may select a plurality of high speed signal paths, select all the high speed signal paths in a same layer on the PCB, or select all the high speed signal paths of the PCB design file. Selections of the high speed signal paths may be determined according to layout checking requirements. For simplification, one high speed signal path is selected as an example in the following descriptions.

The selected high speed signal path may be divided into one or more segments. For example, if the selected high speed signal path is a beeline (single straight line), the selected high speed signal path is regarded as a segment. If the selected high speed signal path is combined with multiple beelines and arcs, the selected high speed signal path may be divided into multiple segments according to a number of the beelines and arcs. A standard for dividing the segments may be modified by the user.

The determination module 24 determines a reference layer of the determined layer which has the selected high speed signal path according to the checking condition, and determines a split line of the reference layer. In some embodiments, the split line is an anti-etch line, which may be drawn using the ALLEGRO software provided by the CADENCE company.

The calculation module 26 calculates a shortest distance between each of the segments of the selected high speed signal path and the split line. If there is a segment crossing the split line, the calculation module 26 determines that the shortest distance between the segment and the split line is zero.

The checking module 28 determines one or more invalid segments by determining if the shortest distance between each of the segments and the split line is less than the standard distance. If a shortest distance between a segment and the split line is less than the standard distance, the checking module 28 determines that layout of the segment is invalid, and the segment is the invalid segment. If the shortest distance between the segment and the split line is not less than the standard distance, the checking module 28 determines that layout of the segment is valid, and the segment is the valid segment.

The indication module 29 indicates locations of the one or more invalid segments by displaying the locations of the one or more invalid segments on the display 14. The indication module 29 further displays information of the one or more invalid segments, the reference layer, and the split line of the reference line, on the display 14.

In other embodiments, the presetting module 20 may further preset a limitation condition to improve efficiency in the determination of the reference layer. The limitation condition is used to limit the determination module 24 to check an upper layer or a lower layer of the determined layer merely, and determine if the upper layer or the lower layer of the determined layer is the reference layer of the determined layer.

In detail, if the upper layer of the determined layer is the power layer or ground layer, the determination module 24 determines the upper layer as the reference layer. If the lower layer is the power layer or ground layer, the determination module 24 determines the lower layer as the reference layer.

If both of the upper layer and lower layer are the power layers or the ground layers, the determination module 24 determines that both of the upper layer and lower layer are the reference layers. If neither the upper layer nor the lower layer is the power layer or ground layer, the determination module 24 returns an indication that no reference layer is found.

FIG. 2 is a schematic diagram of one embodiment of a user interface provided by the electronic device of FIG. 1. Referring to FIG. 2, the user interface may provide a plurality of columns to display or input relevant data, such as a standard distance input column, a high speed signal path selection column, an invalid layout list column, a locations and distances column, and a checking button.

The user may input and modify the standard distance through the standard distance input column, for example, the standard distance may preset as 20 mil. The high speed signal path selection column displays a list of all high speed signal paths in the PCB design file. The user may select one or more high speed signal paths from the list of all high speed signal paths by clicking on names of the high speed signal paths. As shown in FIG. 2, a high speed signal path “USB8N” is selected as an example.

The invalid layout list column displays a list of the high speed signal paths which contain invalid segments. The locations and distances column displays a shortest distance between each segment of the selected high speed signal path and the split line, coordinates of a start point of each segment, and coordinates of an end point of each segment. The checking button may be pressed or clicked by the user to invoke the layout distance checking system 2, to check the layout of the high speed signal paths in the PCB design file.

FIG. 2 is merely an example of data provided by the layout distance checking system 2. In other embodiments, more data may be presented to the user according to the layout checking requirements.

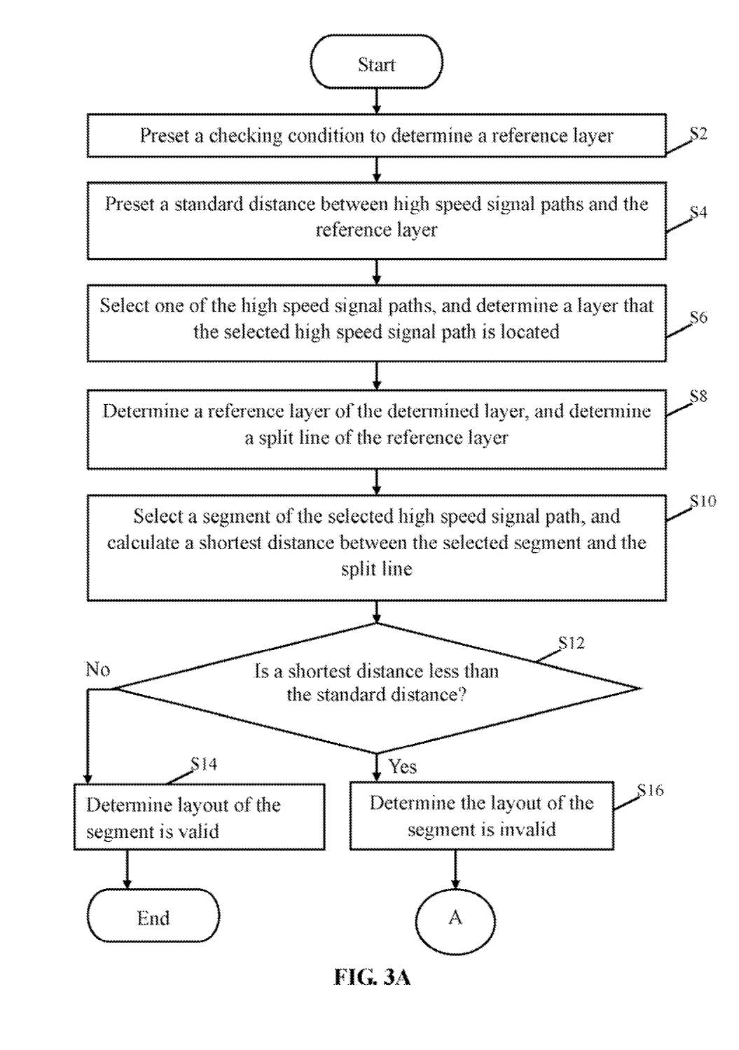

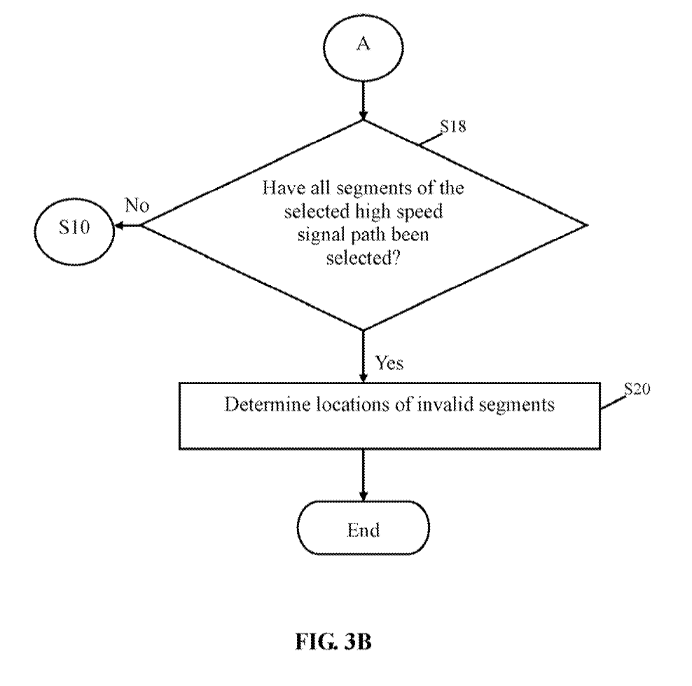

FIG. 3 is a flowchart of a method for checking layout distance of a PCB using the electronic device 1 of FIG. 2. Depending on the embodiment, additional blocks may be added, others removed, and the ordering of the blocks may be replaced.

In block S2, the presetting module 20 presets a checking condition to determine a power layer or a ground layer in the PCB design file nearest to a layer in the PCB design file having high speed signal paths as a reference layer.

In block S4, the presetting module 20 presets a standard distance between the high speed signal paths and the edge of the reference layer.

In block S6, the selection module 22 selects one of the high speed signal paths from the PCB design file stored in the storage device 12, and determines a layer where the selected high speed signal path is located. As mentioned above, the selected high speed signal path may be divided into one or more segments.

In block S8, the determination module 24 determines a reference layer of the determined layer which has the selected high speed signal path according to the checking condition, and determines a split line of the reference layer.

In block S10, the calculation module 26 selects a segment of the selected high speed signal path, and calculates a shortest distance between the selected segment and the split line.

In block S12, the checking module 28 determines if the shortest distance between the selected segment and the split line is less than the standard distance.

If the shortest distance between the selected segment and the split line is less than the standard distance, in block S14, the checking module 28 determines that layout of the selected segment is invalid, and the selected segment is an invalid segment.

If the shortest distance between the selected segment and the split line is not less than the standard distance, in block S16, the checking module 28 determines that the layout of the segment is valid, and the segment is a valid segment.

In block S18, the calculation module determines if all segments of the selected high speed signal path have been selected.

If the selected high speed signal path still has one or more segments which have not been selected, the procedure returns to block S10.

If all segments of the selected high speed signal path have been selected, in block S20, the indication module 29 indicates locations of the invalid segment(s) by displaying the locations of the one or more invalid segments on the display 14.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for checking layout distance of a printed circuit board (PCB) using an electronic device, the electronic device comprising a storage device to store a PCB design file, the method comprising:
presetting a checking condition to determine a power layer or a ground layer in the PCB design file nearest to a layer in the PCB design file having high speed signal paths as a reference layer, and presetting a standard distance between the high speed signal paths and an edge of the reference layer;
selecting one of the high speed signal paths from the PCB design file, and determining a layer where the selected high speed signal path is located, the selected high speed signal path comprising one or more segments;
determining a reference layer of the determined layer according to the checking condition, and determining a split line of the reference layer;
calculating a shortest distance between each of the one or more segments of the selected high speed signal path and the split line; and
determining invalid segments under the condition that the shortest distance between each of the invalid segments and the split line is less than the standard distance.

2. The method according to claim 1, further comprising: displaying locations of the invalid segments, information of the invalid segments, the reference layer, and the split line of the reference line on a display of the electronic device.

3. The method according to claim 1, further comprising:
determining that the shortest distance between a segment of the selected high speed signal path and the split line is zero, under the condition that the segment crosses the split line.

4. The method according to claim 1, further comprising:
presetting a limitation condition to check if an upper layer or a lower layer of the determined layer is the power layer or ground layer.

5. The method according to claim 4, further comprising:
determining the reference layer of the determined layer by checking if the upper layer or lower layer of the determined layer is the power layer or ground layer according to the limitation condition.

6. The method according to claim 5, further comprising:
determining the upper layer as the reference layer if the upper layer of the determined layer is the power layer or ground layer, and determining the lower layer as the reference layer if the lower layer of the determined layer is the power layer or ground layer; or
returning an indication that no reference layer is found, if neither the upper layer nor the lower layer of the determined layer is the power layer or ground layer.

7. An electronic device, the electronic device comprising:
a display;
a storage device storing a printed circuit board (PCB) design file;
at least one processor; and
one or more programs stored in the storage device and being executable by the at least one processor, the one or more programs comprising:
a presetting module operable to preset a checking condition to determine a power layer or a ground layer in the PCB design file nearest to a layer in the PCB design file having high speed signal paths as a reference layer, and preset a standard distance between the high speed signal paths and an edge of the reference layer;
a selection module operable to select one of the high speed signal paths from the PCB design file, and determine a layer where the selected high speed signal path is located, the selected high speed signal path comprising one or more segments;
a determination module operable to determine a reference layer of the determined layer according to the checking condition, and determine a split line of the reference layer;
a calculation module operable to calculate a shortest distance between each of the one or more segments of the selected high speed signal path and the split line; and
a checking module operable to determine invalid segments under the condition that the shortest distance between each of the invalid segments and the split line is less than the standard distance.

8. The electronic device according to claim 7, wherein the one or more programs further comprises an indication module operable to display locations of the invalid segments, information of the invalid segments, the reference layer, and the split line of the reference line on the display of the electronic device.

9. The electronic device according to claim 7, wherein the calculation module is further operable to determine hat the shortest distance between a segment of the selected high speed signal path and the split line is zero, under the condition that the segment crosses the split line.

10. The electronic device according to claim 7, wherein the presetting module is further operable to preset a limitation condition to check if an upper layer or a lower layer of the determined layer is the power layer or ground layer.

11. The electronic device according to claim 10, wherein the determination module is further operable to determine the reference layer of the determined layer by checking if the upper layer or lower layer of the determined layer is the power layer or ground layer according to the limitation condition.

12. The electronic device according to claim 11, wherein the determination module determines the upper layer as the reference layer if the upper layer of the determined layer is the power layer or ground layer, and determines the lower layer as the reference layer if the lower layer of the determined layer is the power layer or ground layer, or returns an indication that no reference layer is found, if neither the upper layer nor the lower layer of the determined layer is the power layer or ground layer.

13. A non-transitory storage medium storing a set of instructions, the set of instructions capable of being executed by a processor to perform a method for checking layout distance of a printed circuit board (PCB) using an electronic device, the electronic device comprising a storage device to store a PCB design file, the method comprising:
presetting a checking condition to determine a power layer or a ground layer in the PCB design file nearest to a layer in the PCB design file having high speed signal paths as a reference layer, and presetting a standard distance between the high speed signal paths and an edge of the reference layer;
selecting one of the high speed signal paths from the PCB design file, and determining a layer where the selected high speed signal path is located, the selected high speed signal path comprising one or more segments;
determining a reference layer of the determined layer according to the checking condition, and determining a split line of the reference layer;
calculating a shortest distance between each of the one or more segments of the selected high speed signal path and the split line; and
determining invalid segments under the condition that the shortest distance between each of the invalid segments and the split line is less than the standard distance.

14. The storage medium as claimed in claim 13, wherein the method further comprises:
displaying locations of the invalid segments, information of the invalid segments, the reference layer, and the split line of the reference line on a display of the electronic device.

15. The storage medium as claimed in claim 13, wherein the method further comprises:
determining that the shortest distance between a segment of the selected high speed signal path and the split line is zero, under the condition that the segment crosses the split line.

16. The storage medium as claimed in claim 13, wherein the method further comprises:
presetting a limitation condition to check if an upper layer or a lower layer of the determined layer is the power layer or ground layer.

17. The storage medium as claimed in claim 16, wherein the method further comprises:
determining the reference layer of the determined layer by checking if the upper layer or lower layer of the determined layer is the power layer or ground layer according to the limitation condition.

18. The storage medium as claimed in claim 17, wherein the method further comprises:
determining the upper layer as the reference layer if the upper layer of the determined layer is the power layer or ground layer, and determining the lower layer as the reference layer if the lower layer of the determined layer is the power layer or ground layer; or
returning an indication that no reference layer is found, if neither the upper layer nor the lower layer of the determined layer is the power layer or ground layer.
